(19) United States
(12) Patent Application Publication
(10) Pub. No.: US 2026/0230012 A1
(43) Pub. Date: Aug. 6, 2026

(54) MOTOR DRIVER HAVING AUTOMATIC STARTUP TORQUE MODULATION MECHANISM

(71) Applicant: ANPEC ELECTRONICS CORPORATION, HSINCHU (TW)

(72) Inventor: MING-JUNG TSAI, CHANGHUA COUNTY (TW)

(21) Appl. No.: 19/180,089

(22) Filed: Apr. 15, 2025

(30) Foreign Application Priority Data
Feb. 5, 2025 (TW) 114104061

(51) Int. Cl. H02P 1/04

(52) U.S. Cl. CPC H02P 1/04

(57) ABSTRACT

A motor driver having an automatic startup torque modulation mechanism that detects state data of a motor. The state data of the motor includes a rotational direction of the motor. The state data of the motor includes a rotational direction of the motor and a rotational speed of the motor. The motor driver sets a plurality of startup parameters according to the state data of the motor that is detected. The motor driver establishes or modulates a plurality of waveforms of a startup waveform signal according to the plurality of startup parameters. The motor driver starts the motor according to the startup waveform signal.

### CROSS-REFERENCE TO RELATED PATENT APPLICATION

This application claims the benefit of priority to Taiwan Patent Application No. 114104061, filed on Feb. 5, 2025. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a motor driver, and more particularly to a motor driver having an automatic startup torque modulation mechanism.

### BACKGROUND OF THE DISCLOSURE

During operation, circuit components of electronic products generate heat, especially in a sealed case or other enclosed space. The heat generated by the operation of the circuit components will circulate in the sealed case, heating other circuit components and causing overheating and damage to the circuit components. Therefore, fans must be installed in electronic products to cool the circuit components of the electronic products.

However, when a fan installed in an electronic device is removed due to being damaged or replaced, the gas in the air will flow back to a space originally accommodating the fan, thus causing the new fan to rotate in a reverse rotational direction after the new fan is installed. Furthermore, the rotational speed of a reverse rotation of the new fan is usually quite high. Conventional motor drivers are unable to effectively start the new fan in a forward rotation when there is headwind near the new fan or when the new fan is in the reverse rotation.

### SUMMARY OF THE DISCLOSURE

In response to the above-referenced technical inadequacies, the present disclosure provides a motor driver having an automatic startup torque modulation mechanism. The motor driver having the automatic startup torque modulation mechanism includes a motor state detection circuit, a startup reference setting circuit, and a motor startup circuit. The motor state detection circuit is configured to detect state data of a motor to output a motor state detection signal. The state data of the motor includes a rotational speed and the rotational direction of the motor, or a combination thereof. The startup reference setting circuit is connected to the motor state detection circuit. The startup reference setting circuit is configured to set a plurality of startup parameters according to the motor state detection signal. The motor startup circuit is connected to the startup reference setting circuit and the motor. The motor startup circuit is configured to establish or modulate a plurality of waveforms of a startup waveform signal according to the plurality of startup parameters, and start the motor based on the startup waveform signal.

Therefore, the present disclosure provides a motor driver having an automatic startup torque modulation mechanism. In the motor driver of the present disclosure, a plurality of startup parameters can be set according to the rotational speed or the rotational direction of the motor, or a combination thereof, and a startup waveform signal used to start the motor can be established or modulated according to the plurality of startup parameters that are set. Specifically, when the motor is in a reverse rotation, the motor driver of the present disclosure is able to establish or modulate the startup waveform signal used to start the motor in a forward rotation. Therefore, a greater startup torque can be provided to the motor and a success rate of starting the motor in an environment having a strong airflow, causing the reverse rotation in the motor, is increased.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a block diagram of a motor driver having an automatic startup torque modulation mechanism according to a first embodiment of the present disclosure;

FIG. 2 is a block diagram of the motor driver according to a second embodiment of the present disclosure;

FIG. 3 is a block diagram of a startup reference setting circuit included in the motor driver according to a third embodiment of the present disclosure;

FIG. 4A is a schematic diagram showing a duty cycle of the motor driver modulated as a motor reverse rotational speed is changed according to the third embodiment of the present disclosure;

FIG. 4B is a schematic diagram showing the change in the duty cycle of a startup waveform signal of the motor driver according to the third embodiment of the present disclosure;

FIG. 5 is a schematic diagram showing an acceleration time of the motor driver modulated along with the change of the motor reverse rotational speed according to the third embodiment of the present disclosure;

FIG. 6 is a schematic diagram showing an acceleration constant of the motor driver modulated along with the change of the motor reverse rotational speed according to the third embodiment of the present disclosure;

FIG. 7 is a waveform diagram of a startup waveform signal established by the motor driver when the motor reverse rotational speed is relatively high according to a fourth embodiment of the present disclosure;

FIG. 8 is a waveform diagram of the startup waveform signal established by the motor driver when the motor reverse rotational speed is relatively low according to the fourth embodiment of the present disclosure;

FIG. 9 is a waveform diagram of a plurality of startup waveform signals having different amplitudes established by a motor driver according to a fifth embodiment of the present disclosure; and

FIG. 10 is a schematic diagram of a fan started by the motor driver according to the first to fifth embodiments of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

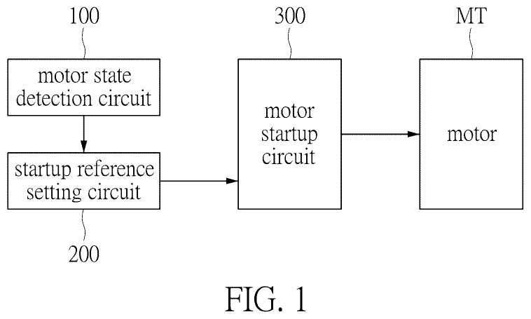

Referring to FIG. 1, which is a block diagram of a motor driver having an automatic startup torque modulation mechanism according to a first embodiment of the present disclosure.

The motor driver of the present disclosure is suitable for starting a motor MT. The motor MT applicable to the motor driver of the present disclosure includes a single-phase motor, a three-phase motor, or a combination thereof.

As shown in FIG. 1, in a first embodiment, the motor driver of the present disclosure includes a motor state detection circuit 100, a startup reference setting circuit 200, and a motor startup circuit 300. The motor state detection circuit 100 is connected to the startup reference setting circuit 200. The motor startup circuit 300 is connected to the startup reference setting circuit 200 and the motor MT.

The motor state detection circuit 100 detects state data of the motor MT to output a motor state detection signal. The startup reference setting circuit 200 sets a plurality of startup parameters according to the state data of the motor MT included in the motor state detection signal received from the motor state detection circuit 100.

The motor startup circuit 300 uses a plurality of waveforms of a startup waveform signal or modulates a preset or previously modulated startup waveform signal according to a plurality of startup parameters received from the startup reference setting circuit 200, and the motor startup circuit 300 starts the motor MT according to the established or modulated startup waveform signal.

It should be noted that, the state data of the motor MT detected by the motor state detection circuit 100 included in the motor driver of the present disclosure includes a rotational direction of the motor MT, and the rotational direction of the motor MT includes a forward rotation and a reverse rotation, or a clockwise rotation and a counter-clockwise rotation. If necessary, the state data of the motor MT detected by the motor state detection circuit 100 may further include a rotational speed of the motor MT.

Therefore, the motor startup circuit 300 included in the motor driver of the present disclosure can set and modulate the starting of the motor MT according to the current rotational direction (and a rotational speed) of the motor MT. Thus, when the motor MT rotates in any rotational direction (and a rotational speed), the motor driver of the present disclosure can successfully start the motor MT. Specifically, when the motor MT rotates in the reverse rotational direction or a headwind flows toward the motor MT, the motor driver of the present disclosure can still successfully start the motor MT to rotate in the forward rotational direction.

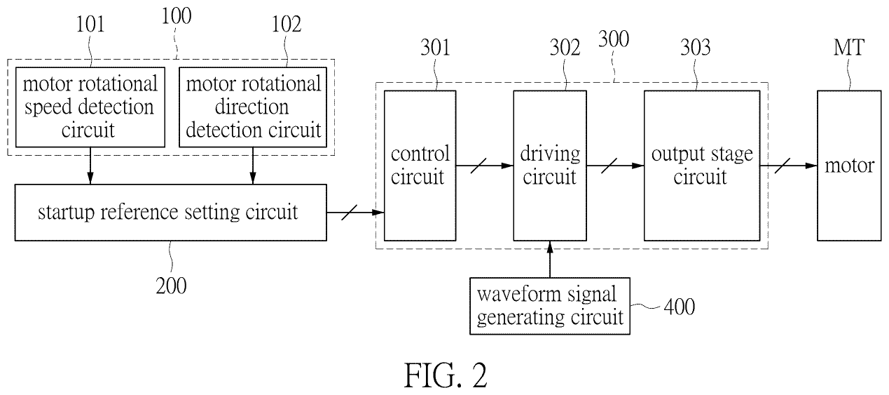

Reference is made to FIG. 2, which is a block diagram of the motor driver according to a second embodiment of the present disclosure.

As shown in FIG. 2, in the second embodiment, the motor driver of the present disclosure includes a motor state detection circuit 100, a startup reference setting circuit 200, a motor startup circuit 300, and a waveform signal generating circuit 400. The motor state detection circuit 100 includes a motor rotational speed detection circuit 101 and a motor rotational direction detection circuit 102. The motor startup circuit 300 includes a control circuit 301, a driving circuit 302, and an output stage circuit 303.

The startup reference setting circuit 200 is connected to the motor rotational speed detection circuit 101, the motor rotational direction detection circuit 102, and the control circuit 301. The driving circuit 302 is connected to the control circuit 301 and the output stage circuit 303. The output stage circuit 303 is connected to the motor MT. The waveform signal generating circuit 400 is connected to the driving circuit 302.

The motor rotational speed detection circuit 101 detects the rotational speed of the motor MT to output a rotational speed detection signal to the startup reference setting circuit 200. The motor rotational direction detection circuit 102 detects the rotational direction of the motor MT to output a rotational direction detection signal to the startup reference setting circuit 200.

The startup reference setting circuit 200 sets a plurality of startup parameters according to the rotational speed detection signal received from the motor rotational speed detection circuit 101 and the rotational direction detection signal received from the motor rotational direction detection circuit 102.

The motor state detection circuit 100 can detect the motor MT for multiple times and obtain a plurality of state data sets, respectively. The plurality of state data sets are data of the motor MT detected in a plurality of time intervals, respectively. Each of the state data sets includes the rotational direction and the rotational speed of the motor MT, the rotational direction may include forward rotation and reverse rotation, and the rotational speed may include high rotational speed and low rotational speed. The forward rotation may include a designated forward rotational direction as described below, and the reverse rotation may include a designated reverse rotational direction as described below.

The startup reference setting circuit 200 can set a plurality of startup parameter sets respectively according to a plurality of state data sets included in a motor state detection signal received from the motor state detection circuit 100. Each of the plurality of startup parameter sets includes a plurality of startup parameters.

The control circuit 301 respectively establishes waveforms of a plurality of startup waveform signals or modulates waveforms of a plurality of preset or previously modulated startup waveform signals according to the plurality of startup parameter sets received from the startup reference setting circuit 200.

The waveform signal generating circuit 400 may output a plurality of reference waveform signals, or only generate one reference waveform signal in practice.

The driving circuit 302 respectively compares voltages of the startup waveform signals obtained from the waveform signal generating circuit 400 with voltages of a reference waveform signal to determine voltage levels of waveforms of a plurality of driving signals and output the plurality of driving signals. The startup waveform signal may include a plurality of sine wave waveforms, a plurality of third harmonic waveforms, or any combination thereof. The reference waveform signal may include a triangle waveform, a plurality of sawtooth waveforms, or any combination thereof.

The output stage circuit 303 is operated according to the plurality of driving signals received from the driving circuit 302 to output a motor startup signal to the motor MT and start the motor MT. The output stage circuit 303 may include a plurality of high-side switches and a plurality of low-side switches, various configurations thereof are well known in the art and will not be described herein, and the present disclosure is not limited thereto.

For example, when the rotational direction of the motor MT is the same as a designated forward rotational direction, the control circuit 301 outputs a startup waveform signal that is the same as a first startup pattern waveform signal. On the other hand, when the rotational direction of the motor MT is different from the designated forward rotational direction, the control circuit 301 outputs a startup waveform signal that is the same as a second startup pattern waveform signal. Parameters of a plurality of waveforms of the second startup pattern waveform signal, such as amplitude, are respectively different from parameters of a plurality of waveforms of the first startup pattern waveform signal, such as amplitude.

Alternatively, when the rotational direction of the motor MT is different from a designated reverse rotational direction, the control circuit 301 outputs a startup waveform signal that is the same as the first startup pattern waveform signal. On the other hand, when the rotational direction of the motor MT is the same as the designated reverse rotational direction, the control circuit 301 outputs a startup waveform signal that is the same as the second startup pattern waveform signal.

Alternatively, when the motor MT rotates in a designated forward rotational direction or when the rotational speed of the motor MT rotating in a designated forward rotational direction does not exceed a rotational speed threshold, the control circuit 301 outputs a startup waveform signal that is the same as the first startup pattern waveform signal. On the other hand, when the rotational speed of the motor MT rotating in the designated reverse rotational direction exceeds the rotational speed threshold, the control circuit 301 outputs a startup waveform signal that is the same as the second startup pattern waveform signal.

The motor MT may be operated at different rotational speeds in the same designated forward rotational direction within a plurality of forward rotation time intervals. Therefore, the control circuit 301 generates a plurality of forward startup pattern waveform signals that respectively correspond to a plurality of reference rotational speed ranges. In each of the plurality of forward rotation time intervals, the startup waveform signal output by the control circuit 301 is the same as a forward startup pattern waveform signal corresponding to the reference rotational speed range within which the rotational speed of the motor MT falls. The parameters (including the amplitude and the duty cycle) of the waveforms of each of the plurality of forward startup pattern waveform signals are different from the parameters (including the amplitude and the duty cycle) of the waveforms of the other forward startup pattern waveform signals.

The motor MT may also rotate at different speeds in the same designated reverse direction within a plurality of reverse rotation time intervals. Therefore, the control circuit 301 generates a plurality of reverse startup pattern waveform signals that respectively correspond to a plurality of reference rotational speed ranges. In each of the plurality of reverse rotation time intervals, the startup waveform signal output by the control circuit 301 is the same as a reverse startup pattern waveform signal corresponding to the reference rotational speed range within which the rotational speed of the motor MT falls. The parameters (including the amplitude and the duty cycle) of the waveforms of each of the plurality of reverse startup pattern waveform signals are different from the parameters (including the amplitude and the duty cycle) of the waveforms of the other reverse startup pattern waveform signals.

If necessary, the control circuit 301 may store a plurality of reference startup parameter sets and a plurality of corresponding startup pattern waveform signals. The control circuit 301 may use a startup pattern waveform signal corresponding to the reference startup parameter set that is the same as the startup parameter set according to the currently detected state data set of the motor MT as a startup waveform signal.

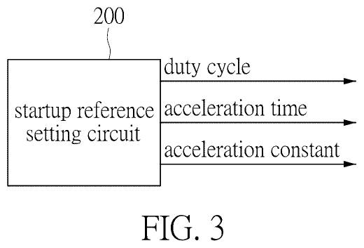

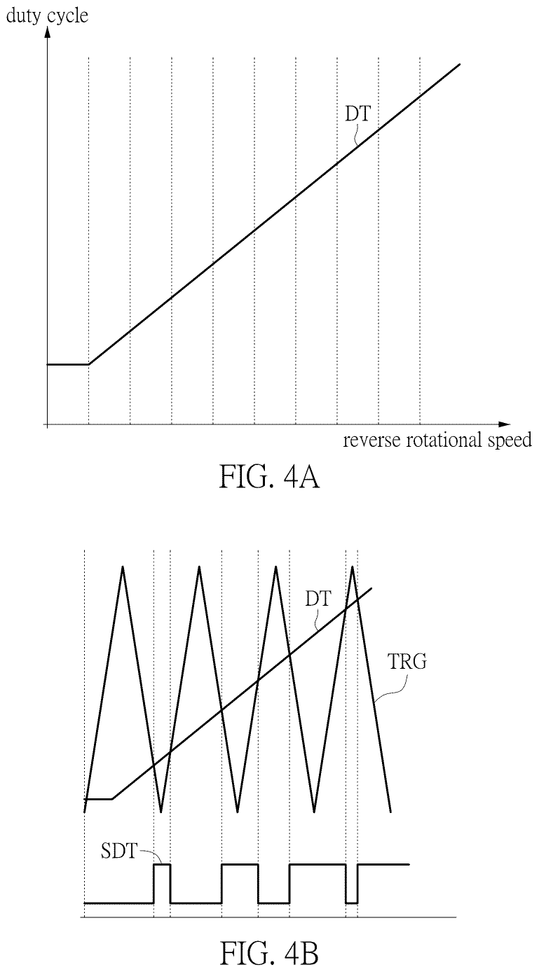

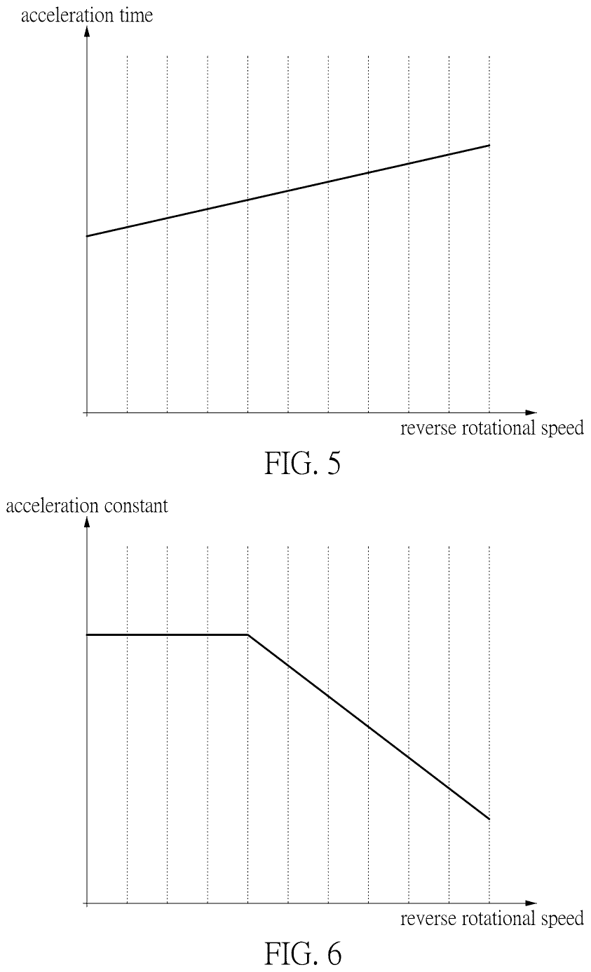

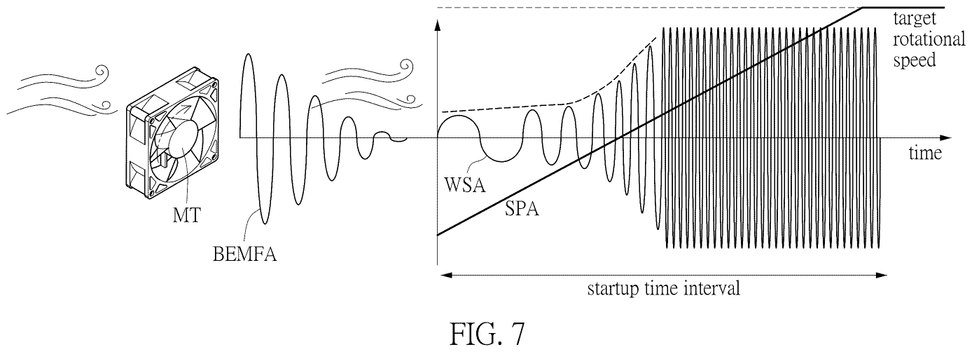

Referring to FIG. 3 to FIG. 6, FIG. 3 is a block diagram of a startup reference setting circuit included in the motor driver according to a third embodiment of the present disclosure, FIG. 4A is a schematic diagram showing a duty cycle of the motor driver modulated as a motor reverse rotational speed is changed according to the third embodiment of the present disclosure, FIG. 4B is a schematic diagram showing the change in the duty cycle of a startup waveform signal of the motor driver according to the third embodiment of the present disclosure, FIG. 5 is a schematic diagram showing an acceleration time of the motor driver modulated along with the change of the motor reverse rotational speed according to the third embodiment of the present disclosure, and FIG. 6 is a schematic diagram showing an acceleration constant of the motor driver modulated along with the change of the motor reverse rotational speed according to the third embodiment of the present disclosure.

The plurality of startup parameters set by the startup reference setting circuit 200 as shown in FIG. 1 and FIG. 2 may include a duty cycle, an acceleration time, an acceleration constant, or any combination thereof as shown in FIG. 3 to FIG. 6.

The control circuit 301 as shown in FIG. 2 can establish or modulate multiple waveforms of a startup waveform signal SDT as shown in FIG. 4B according to the duty cycle, the acceleration time, and the acceleration constant as shown in FIG. 3 to FIG. 6 set by the startup reference setting circuit 200, as described in detail below.

The duty cycle of a waveform of a startup waveform signal SDT established or modulated by the motor startup circuit 300 as shown in FIG. 1 and FIG. 2 is the same as the duty cycle included in the plurality of startup parameters received from the startup reference setting circuit 200.

It should be noted that, the duty cycle of the startup waveform signal SDT is working periods of the startup waveform signal SDT divided by the sum of working periods and non-working periods of the waveform.

A reverse startup duty cycle variation curve DT as shown in FIG. 4A represents that the duty cycle set by the startup reference setting circuit 200 increases as the rotational speed of the motor MT increases in the reverse rotation. Therefore, the duty cycle of a startup waveform signal SDT as shown in FIG. 4B established by the motor startup circuit 300 based on the duty cycle set by the startup reference setting circuit 200 (and a triangle wave signal TRG) also increases as the rotational speed of the motor MT increases in the reverse rotation.

It should be noted that, the greater the duty cycle of the startup waveform signal SDT outputted by the motor startup circuit 300 to the motor MT is, the greater the torque applied to the motor MT is.

On the other hand, as shown in FIG. 4A and FIG. 4B, when the motor MT rotates in a designated reverse rotational direction, the duty cycle set by the startup reference setting circuit 200 and the duty cycle of a startup waveform signal SDT established or modulated by the motor startup circuit 300 decrease as the rotational speed of the motor MT decreases.

As shown in FIG. 5, when the motor MT rotates in a designated reverse rotational direction, the acceleration time set by the startup reference setting circuit 200 and an acceleration constant set by the startup reference setting circuit 200 as shown in FIG. 6 increase as the rotational speed of the motor MT increases.

When the reverse rotational speed of the motor MT exceeds a reverse rotational speed threshold, the acceleration constant set by the startup reference setting circuit 200 may decrease as the rotational speed of the motor MT increases, as shown in FIG. 6.

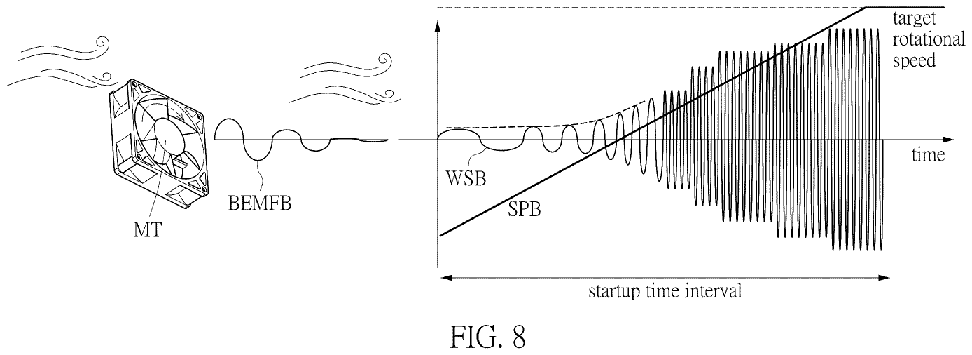

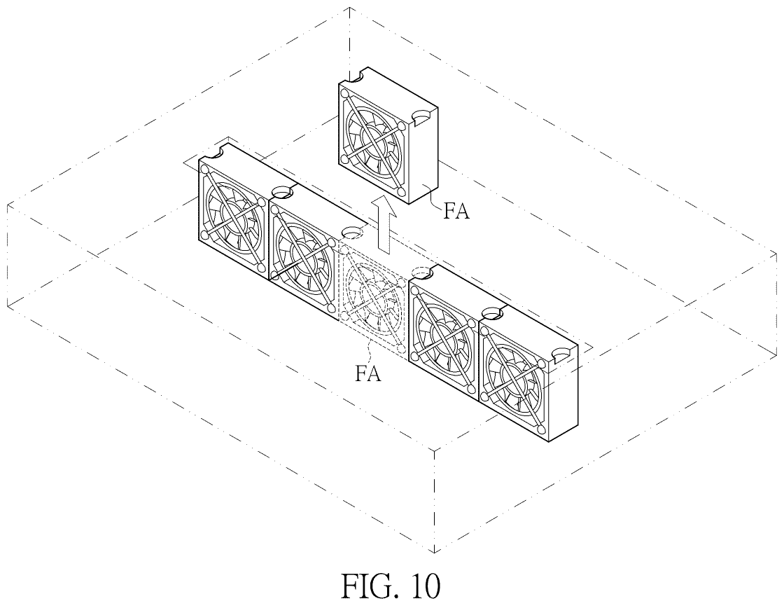

Referring to FIG. 7, FIG. 8, and FIG. 10, FIG. 7 is a waveform diagram of a startup waveform signal established by the motor driver when the motor reverse rotational speed is relatively high according to a fourth embodiment of the present disclosure, FIG. 8 is a waveform diagram of the startup waveform signal established by the motor driver when the motor reverse rotational speed is relatively low according to the fourth embodiment of the present disclosure, and FIG. 10 is a schematic diagram of a fan started by the motor driver according to the first to fifth embodiments of the present disclosure.

The motor MT for which the motor driver of the present disclosure is suitable to startup may be as shown in FIG. 7 and FIG. 8, and the motor MT may be disposed in the fan FA as shown in FIG. 10.

When the fan FA installed in the electronic device is replaced due to damage and is removed as shown in FIG. 10, air may flow back to an accommodating space originally accommodating the fan FA, causing the motor of a new one of the fan FA to rotate in reverse when the new one of the fan FA is reinstalled, thus driving fan blades of the new one of the fan FA to rotate in reverse. Since the reverse flow of the headwind causes the fan blades to rotate in reverse, resistance is present for starting the motor MT to perform the forward rotation, such that it is difficult to start the motor MT smoothly. Therefore, if the motor MT is to be started to rotate forward at a target speed, a startup torque applied to the motor MT of the fan FA rotating in the reverse rotational direction must be greater than a startup torque of the motor MT of the fan FA when there is no headwind or reverse rotation.

That is, the greater the speed at which the motor MT rotates in a designated reverse rotational direction is, the greater the amplitudes of a plurality of waveforms of a startup waveform signal set by the motor startup circuit 300 are.

For example, the rotational speed indicated by a reverse rotational speed signal SPA of the motor MT as shown in FIG. 7 is greater than the rotational speed indicated by a reverse rotational speed signal SPB of the motor MT as shown in FIG. 8. The amplitude of a back electromotive force signal BEMFA of the motor MT as shown in FIG. 7 is greater than the amplitude of a back electromotive force signal BEMFB of the motor MT as shown in FIG. 8. Therefore, the amplitudes of the plurality of waveforms of a startup waveform signal generated by the motor driver of the present disclosure in the example of FIG. 7 are respectively greater than the amplitudes of the plurality of waveforms of a startup waveform signal in the example of FIG. 8. The amplitudes of the plurality of waveforms of a motor current signal WSA supplied by the motor driver of the present disclosure to the motor MT in the example of FIG. 7 are respectively greater than the amplitudes of the plurality of waveforms of a motor current signal WSB supplied to the motor MT in the example of FIG. 8.

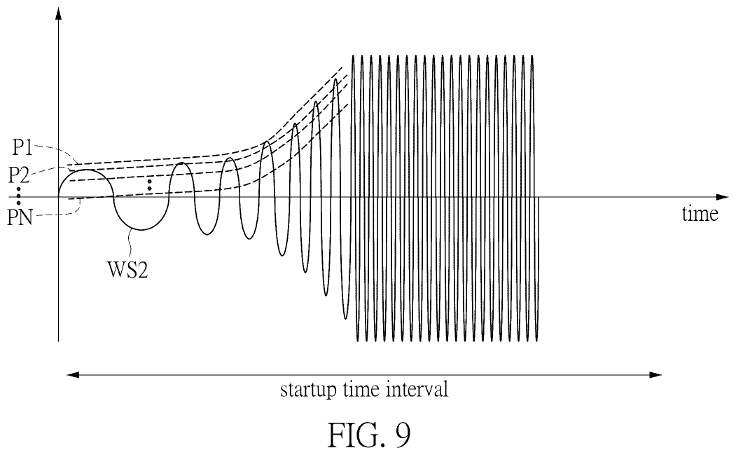

Referring to FIG. 9, FIG. 9 is a waveform diagram of a plurality of startup waveform signals having different amplitudes established by a motor driver according to a fifth embodiment of the present disclosure.

The motor startup circuit 300 or the control circuit 301 as shown in FIG. 1 or FIG. 2 included in the motor driver of the present disclosure can set a different plurality of startup waveform signals according to different rotational speeds of the motor MT along a designated reverse rotational direction, including a startup waveform signal WS2 as shown in FIG. 9.

The peak values of the plurality of waveforms of each of the plurality of startup waveform signals respectively set according to different rotational speeds of the motor MT in a designated reverse rotational direction are different from the peak values of the plurality of waveforms of the other startup waveform signals. Therefore, a peak connection line formed by connecting the peak values of the plurality of waveforms of each of the plurality of startup waveform signals is different from a peak connection line formed by connecting the peak values of the plurality of waveforms of the other startup waveform signals. For example, peak connection lines of the startup waveform signals are respectively the same as peak connection lines P1 to PN as shown in FIG. 9. Accordingly, the amplitudes of the plurality of waveforms of each of the startup waveform signals are different from the amplitudes of the plurality of waveforms of the other startup waveform signals.

In conclusion, the present disclosure provides a motor driver having an automatic startup torque modulation mechanism. In the motor driver of the present disclosure, a plurality of startup parameters can be set according to the rotational speed or the rotational direction of the motor, or a combination thereof, and a startup waveform signal used to start the motor can be established or modulated according to the plurality of startup parameters that are set. Specifically, when the motor is in a reverse rotation, the motor driver of the present disclosure is able to establish or modulate the startup waveform signal used to start the motor in a forward rotation. Therefore, a greater startup torque can be provided to the motor and a success rate of starting the motor in an environment having a strong airflow, causing the reverse rotation in the motor, is increased.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A motor driver having an automatic startup torque modulation mechanism, and the motor driver comprising:
a motor state detection circuit configured to detect state data of a motor to output a motor state detection signal, wherein the state data of the motor includes a rotational direction of the motor;
a startup reference setting circuit connected to the motor state detection circuit and configured to set a plurality of startup parameters according to the motor state detection signal; and
a motor startup circuit connected to the startup reference setting circuit and the motor, wherein the motor startup circuit is configured to establish or modulate a plurality of waveforms of a startup waveform signal according to the plurality of startup parameters, and start the motor based on the startup waveform signal.

2. The motor driver according to claim 1, wherein the rotational direction of the motor includes a forward rotation and a reverse rotation.

3. The motor driver according to claim 1, wherein the motor startup circuit includes:
a control circuit connected to the startup reference setting circuit and configured to establish or modulate the plurality of waveforms of the startup waveform signal according to the plurality of startup parameters, and output the startup waveform signal;
a driving circuit connected to the control circuit and configured to output a driving signal according to the startup waveform signal; and
an output stage circuit connected to the driving circuit and the motor, wherein the output stage circuit is configured to output a motor startup signal to the motor according to the driving signal.

4. The motor driver according to claim 1, wherein the plurality of startup parameters includes a duty cycle, an acceleration time, an acceleration constant, or a combination thereof.

5. The motor driver according to claim 1, wherein, when the rotational direction of the motor is the same as a designated forward rotational direction, the startup waveform signal output by the motor startup circuit is the same as a first startup pattern waveform signal;
wherein, when the rotational direction of the motor is different from the designated forward rotational direction, the startup waveform signal output by the motor startup circuit is the same as a second startup pattern waveform signal.

6. The motor driver according to claim 1, wherein, when the rotational direction of the motor is different from a designated reverse rotational direction, the startup waveform signal output by the motor startup circuit is the same as a first startup pattern waveform signal;
wherein, when the rotational direction of the motor is the same as the designated reverse rotational direction, the motor startup circuit outputs a second startup pattern waveform signal.

7. The motor driver according to claim 1, wherein the state data of the motor further includes a rotational speed of the motor.

8. The motor driver according to claim 7, wherein, when the rotational speed of the motor rotating in a designated forward rotational direction or the rotational speed of the motor rotating in a designated reverse rotational direction does not exceed a rotational speed threshold, the startup waveform signal output by the motor startup circuit is the same as a first startup pattern waveform signal;
wherein, when the rotational speed of the motor rotating in the designated reverse rotational direction exceeds the rotational speed threshold, the startup waveform signal output by the motor startup circuit is the same as a second startup pattern waveform signal.

9. The motor driver according to claim 7, wherein the startup reference setting circuit sets a plurality of startup parameter sets based on a plurality of state data sets respectively obtained by the motor state detection circuit detecting the motor for a plurality of times, each of the plurality of state data sets includes the rotational speed and the rotational direction of the motor, and each of the startup parameter sets includes a plurality of startup parameters;
wherein the motor startup circuit establishes or modulates the startup waveform signal according to each of the plurality of startup parameter sets.

10. The motor driver according to claim 7, wherein the motor state detection circuit includes:
a motor rotational speed detection circuit connected to the startup reference setting circuit and configured to detect the rotational speed of the motor to output a rotational speed detection signal; and
a motor rotational direction detection circuit connected to the startup reference setting circuit and configured to detect the rotational direction of the motor to output a rotational direction detection signal;
wherein the motor state detection signal includes the rotational speed detection signal and the rotational direction detection signal.

11. The motor driver according to claim 1, wherein, when the rotational direction of the motor is the same as a designated forward rotational direction, the startup waveform signal output by the motor startup circuit is the same as one of a plurality of forward startup pattern waveform signals.

12. The motor driver according to claim 11, wherein the state data of the motor further includes a rotational speed of the motor, the plurality of forward startup pattern waveform signals respectively correspond to a plurality of reference rotational speed ranges, and the startup waveform signal output by the motor startup circuit is the same as the one of the plurality of forward startup pattern waveform signals corresponding to one of the plurality of reference rotational speed ranges within which the rotational speed of the motor falls.

13. The motor driver according to claim 1, wherein, when the rotational direction of the motor is the same as a designated reverse rotational direction, the startup waveform signal output by the motor startup circuit is the same as one of a plurality of reverse startup pattern waveform signals.

14. The motor driver according to claim 13, wherein the state data of the motor further includes a rotational speed of the motor, the plurality of reverse startup pattern waveform signals respectively correspond to a plurality of reference rotational speed ranges, and the startup waveform signal output by the motor startup circuit is the same as the one of the plurality of reverse startup pattern waveform signals corresponding to one of the plurality of reference rotational speed ranges within which the rotational speed of the motor falls.

15. The motor driver according to claim 1, further comprising:
a waveform signal generating circuit connected to the motor startup circuit and configured to output a reference waveform signal;
wherein the motor startup circuit is configured to respectively compare a plurality of voltages of the startup waveform signal with a plurality of voltages of the reference waveform signal to determine a plurality of voltage levels of a plurality of waveforms of a motor startup signal and output the motor startup signal to the motor.

16. The motor driver according to claim 15, wherein the startup waveform signal includes a plurality of sine wave waveforms, a plurality of third harmonic waveforms, or any combination thereof.

17. The motor driver according to claim 15, wherein the reference waveform signals include a triangular waveform, a plurality of sawtooth waveforms, or any combination thereof.

18. The motor driver according to claim 1, wherein the motor includes a single-phase motor.

19. The motor driver according to claim 1, wherein the motor includes a three-phase motor.
